(19) United States
(12) Patent Application Publication
(10) Pub. No.: US 2025/0371806 A1
(43) Pub. Date: Dec. 4, 2025

(54) IMAGE PROCESSING METHOD AND APPARATUS, DEVICE, AND STORAGE MEDIUM

(71) Applicant: Tencent Technology (Shenzhen) Company Limited, Shenzhen (CN)

(72) Inventor: Tianyuan CHANG, Shenzhen (CN)

(21) Appl. No.: 19/296,759

(22) Filed: Aug. 11, 2025

Related U.S. Application Data
(63) Continuation of application No. PCT/CN2024/095687, filed on May 28, 2024.

(30) Foreign Application Priority Data
Jun. 20, 2023 (CN) 202310730294.2

(51) Int. Cl. G06T 17/20; G06T 7/73; G06T 19/20

(52) U.S. Cl. CPC G06T 17/20; G06T 7/75; G06T 19/20; G06T 2200/04; G06T 2207/20084; G06T 2219/2016

(57) ABSTRACT

This application provides an image processing method performed by a computer device. The method includes: obtaining vertex features of vertexes in a mesh model of an object and topology information of the mesh model; obtaining vertex relationship indication information indicating vertexes having a constraint relationship between two different vertexes in the mesh model; and predicting a skin weight of the mesh model by applying the vertex relationship indication information, the vertex features, and the topology information of the mesh model to a skin weight prediction model, the skin weight of the mesh model indicating a deformation influence degree of the joint point of the object on each vertex in the mesh model in a deformation process of the mesh model. By predicting the skin weight of the mesh model, the accuracy of predicting a skinning matrix of the mesh model is improved.

### CROSS-REFERENCE TO RELATED APPLICATIONS

This application is a continuation application of PCT Patent Application No. PCT/CN2024/095687, entitled “IMAGE PROCESSING METHOD AND APPARATUS, DEVICE, AND STORAGE MEDIUM” filed on May 28, 2024, which claims priority to Chinese Patent Application No. 202310730294.2, entitled “IMAGE PROCESSING METHOD AND APPARATUS, DEVICE, AND STORAGE MEDIUM” filed with the China National Intellectual Property Administration on Jun. 20, 2023, both of which are incorporated by reference in their entirety.

### FIELD OF THE TECHNOLOGY

This application relates to the field of computer technologies, and specifically, to an image processing method, an image processing apparatus, a computer device, and a computer-readable storage medium.

### BACKGROUND OF THE DISCLOSURE

With the progress of science and technology research, the animation and game industries develop rapidly. One of technical cores of the animation and game industries is a mesh model of an object, for example, a costume model, a character model, or a scenario model. Because there are a plurality of vertexes in the mesh model of the object, rotation, translation, and transformation of the mesh model of the object are usually indicated by using a skinning matrix corresponding to the mesh model. It is found through research that the skinning matrix corresponding to the mesh model is usually obtained through prediction by using a skin weight prediction model, and accuracy of predicting the skinning matrix of the mesh model is low.

### SUMMARY

Embodiments of this application provide an image processing method and apparatus, a device, and a computer-readable storage medium, to improve accuracy of predicting a skinning matrix of a mesh model.

According to an aspect, an embodiment of this application provides an image processing method performed by a computer device, the method including:
obtaining vertex features of vertexes in a mesh model of an object and topology information of the mesh model, the topology information of the mesh model including a location relationship between a joint point of the object and each vertex in the mesh model and a connection relationship between the vertexes in the mesh model;
obtaining vertex relationship indication information indicating vertexes having a constraint relationship between two different vertexes in the mesh model; and
predicting a skin weight of the mesh model by applying the vertex relationship indication information, the vertex features, and the topology information of the mesh model to a skin weight prediction model, the skin weight of the mesh model indicating a deformation influence degree of the joint point of the object on each vertex in the mesh model in a deformation process of the mesh model.

Correspondingly, this application provides a computer device, including:
a memory, having a computer program stored therein; and
a processor, configured to load the computer program and cause the computer device to implement the foregoing image processing method.

Correspondingly, this application provides a non-transitory computer-readable storage medium, having a computer program stored therein. The computer program is suitable for being loaded and executed by a processor of a computer device and causing the computer device to perform the foregoing image processing method.

According to the embodiments of this application, vertex features of vertexes in a mesh model of an object and topology information of the mesh model are obtained, where a location relationship between a joint point of the object and each vertex in the mesh model and a connection relationship between the vertexes in the mesh model may be obtained by obtaining the topology information. Vertex relationship indication information is obtained, where the vertex relationship indication information may be configured for indicating vertexes having a constraint relationship in the mesh model, and the constraint relationship is a constraint relationship between two different vertexes. The vertex relationship indication information, the vertex features, and the topology information of the mesh model are inputted to a skin weight prediction model, where the skin weight prediction model is configured to predict a skin weight of the mesh model based on the vertex relationship indication information, the vertex features, and the topology information of the mesh model. In this way, the skin weight is predicted based on the vertex relationship indication information, the vertex features, and the topology information, so that in a process of predicting the skin weight of the mesh model, skin weights of the vertexes in the mesh model may be constrained by using the vertex relationship indication information, so that accuracy of predicting a skinning matrix of the mesh model can be improved.

### BRIEF DESCRIPTION OF THE DRAWINGS

FIG. 1A is a diagram of an image processing scenario according to an embodiment of this application.

FIG. 1B is a schematic diagram of image processing according to an embodiment of this application.

FIG. 2 is a flowchart of an image processing method according to an embodiment of this application.

FIG. 3 is a schematic diagram of neighborhood vertexes according to an embodiment of this application.

FIG. 4 is a schematic diagram of an architecture of a skin weight prediction model according to an embodiment of this application.

FIG. 5 is a flowchart of another image processing method according to an embodiment of this application.

FIG. 6 is a schematic diagram of key vertexes according to an embodiment of this application.

FIG. 7 is a schematic diagram of establishing connecting edges between key vertexes according to an embodiment of this application.

FIG. 8 is a schematic diagram of feature conversion of a neighbor submodule according to an embodiment of this application.

FIG. 9 is a schematic structural diagram of a residual submodule according to an embodiment of this application.

FIG. 10 is a diagram of comparison between effects according to an embodiment of this application.

FIG. 11 is a schematic structural diagram of an image processing apparatus according to an embodiment of this application.

FIG. 12 is a schematic structural diagram of a computer device according to an embodiment of this application.

### DESCRIPTION OF EMBODIMENTS

This application relates to technologies related to artificial intelligence and modeling. The related technologies are briefly described below:

Artificial intelligence (AI) is a theory, method, technology, and application system that uses a digital computer or a machine controlled by the digital computer to simulate, extend, and expand human intelligence, perceive an environment, obtain knowledge, and use knowledge to obtain an optimal result. In other words, the AI is a comprehensive technology in computer science. This technology attempts to understand the essence of intelligence and produce a new intelligent machine that can react in a manner similar to human intelligence. The AI is to study the design principles and implementation methods of various intelligent machines, so that the machines can perceive, infer, and make decisions. Embodiments of this application mainly relate to performing, by using a skin weight prediction model, skin weight prediction processing based on vertex relationship indication information, vertex features, and topology information of a mesh model, to obtain a skin weight of the mesh model.

An AI technology is a comprehensive discipline, covering a wide range of fields, including both hardware-level technology and software-level technology. Basic AI technologies generally include technologies such as a sensor, a dedicated AI chip, cloud computing, distributed storage, a big application processing technology, an operating/interaction system, and electromechanical integration. An AI software technology mainly includes fields such as a computer vision technology, a speech processing technology, a natural language processing technology, and machine learning/deep learning.

Machine learning (ML) is a multi-field inter-discipline, and relates to a plurality of disciplines such as the probability theory, statistics, the approximation theory, convex analysis, and the algorithm complexity theory. The ML specializes in studying how a computer simulates or implements a human learning behavior to acquire new knowledge or skills, and reorganize an existing knowledge structure, to keep improving its performance. The ML is the core of the AI, is a basic way to make the computer intelligent, and is applied to various fields of AI. The ML and deep learning generally include technologies such as an artificial neural network, a belief network, reinforcement learning, transfer learning, inductive learning, and learning from demonstrations. In the embodiments of this application, the skin weight prediction model is mainly trained based on a sample data set, to further improve prediction accuracy of the skin weight prediction model.

Mesh model: In game and modeling industries, an object may be approximately represented by using a mesh (for example, a triangle mesh or a polygon mesh). A process of presenting the object by using the mesh is referred to as modeling. A basic diagram element in a three-dimensional world is a triangle. Usually, all constructed three-dimensional models in the three-dimensional world are hollow, and are represented by closed surfaces (mesh bodies). From a perspective of storage, a plane may be determined by three points, and a three-dimensional model may be represented by closed surfaces. Therefore, the mesh model may be formed by vertexes and has neither a “plane” nor a “body”, and no additional information needs to be stored, thereby maximizing compression. It can be seen that, a three-dimensional mesh model seems to be formed by a plurality of triangles (polygons), and vertexes forming the three-dimensional mesh model are stored during storage. A complete mesh model (mesh) may be described by using a series of basic geometrical information. A mesh model of an object involved in this application may be a three-dimensional mesh model or a two-dimensional mesh model. This is not limited in this application.

Skinning is a three-dimensional animation term (which may also be used in a 3D game). The skinning is a technology of manufacturing three-dimensional animation. Based on the mesh model created through a three-dimensional software, a joint point is added to the mesh model (where the joint point may be set based on an actual requirement, for example, for a virtual person, the joint point may be a skeleton of the virtual person). Because the joint point and the mesh model are independent of each other, to make the joint point drive the mesh model to perform transformation (for example, drive the mesh model to move by using the joint point), a technology of binding the mesh model to the joint point is referred to as skinning. A skinning matrix is finally output during the skinning. The skinning matrix includes A*B skin weights (in other words, a dimension of the skinning matrix is A*B), and the skin weight is a value. A is a quantity of vertexes in the model, and B is a quantity of joint points in the model. A skin weight in a row i and a column j of the skinning matrix is configured for indicating a deformation influence degree of a j^{th} joint point on an it vertex in a movement process of the object. i is a positive integer less than or equal to A, and j is a positive integer less than or equal to B. In addition, for each vertex, a sum of weights on all joint points is 1 (in other words, a sum of skin weights in each row is 1).

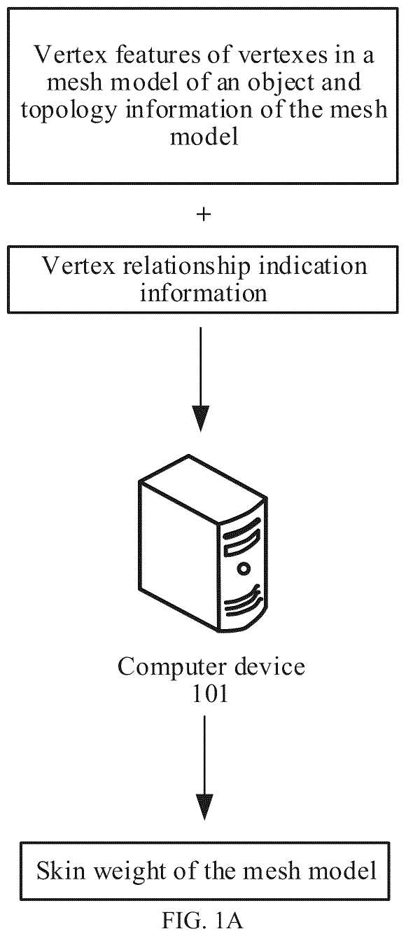

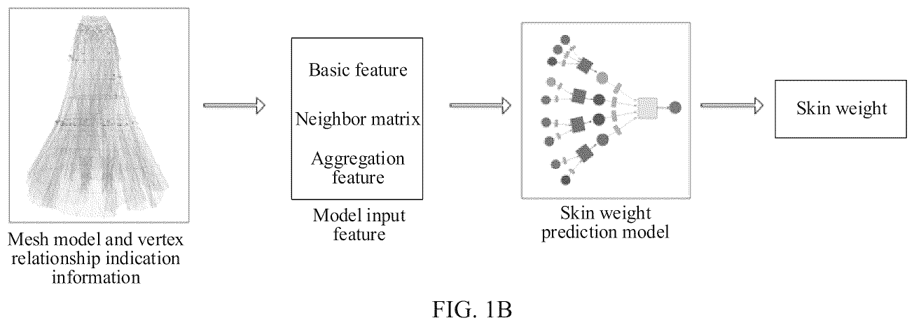

Based on the foregoing technologies related to AI and modeling, the embodiments of this application provide an image processing solution to improve accuracy of predicting the skinning matrix of the mesh model. FIG. 1A is a diagram of an image processing scenario according to an embodiment of this application. As shown in FIG. 1A, the image processing scenario provided in this application includes a computer device 101. The image processing solution provided in this application may be executed by the computer device 101. The computer device 101 may be a terminal device, or may be a server. The terminal device may include, but is not limited to, a smartphone (for example, an Android mobile phone or an IOS mobile phone), a tablet computer, a portable personal computer, a mobile Internet device (MID), an in-vehicle terminal, a smart appliance, a wearable device, and the like. This is not limited in the embodiments of this application. The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. This is not limited in the embodiments of this application.

A quantity of computer devices in FIG. 1A is merely an example, and does not constitute an actual limitation of this application. For example, a computer device 102 (for example, configured to transmit vertex relationship indication information to the computer device 101) may further be included in FIG. 1A. The computer device 101 and the computer device 102 may be connected in a wired or wireless manner. This is not limited in this application.

FIG. 1B is a schematic diagram of image processing according to an embodiment of this application. As shown in FIG. 1B, a general principle of the image processing solution provided in this application is as follows:

(1) The computer device 101 obtains vertex features of vertexes in a mesh model of an object and topology information of the mesh model, the topology information of the mesh model including a location relationship between a joint point of the object and each vertex in the mesh model and a connection relationship between the vertexes in the mesh model. In an implementation, a vertex feature of a vertex is a vertex parameter of the vertex. The vertex feature of each vertex in the mesh model of the object includes at least one of the following: location information of the vertex (for example, a location of the vertex in a Cartesian coordinate system), a normal vector of the vertex, and a second distance (for example, a Euclidean distance) between the vertex and each joint point of the object. The topology information of the mesh model includes a vertex graph topology structure of the mesh model of the object and a joint point graph topology structure of the object. By using the vertex graph topology structure of the mesh model of the object as an example, the vertex graph topology structure of the mesh model of the object includes at least one of the following: the vertexes in the mesh model of the object, connecting edges between the vertexes in the mesh model of the object, and a neighbor matrix of the vertexes in the mesh model of the object. In an embodiment, the vertex features of the vertexes in the mesh model of the object and the topology information of the mesh model may be extracted from the mesh model of the object.

(2) The computer device 101 obtains vertex relationship indication information, the vertex relationship indication information being configured for indicating vertexes having a constraint relationship in the mesh model, and the constraint relationship being a constraint relationship between two different vertexes. In an implementation, the joint point of the object includes at least one basic (general) joint point and P additional joint points corresponding to the mesh model, P being a positive integer. For different mesh models of the same object (for example, different costumes of a same virtual character), basic joint points of the mesh models are the same, and additional joint points of the mesh models may be different. The computer device 101 obtains P key regions in a one-to-one correspondence with the P additional joint points in the mesh model (where the key regions may be indicated by a modeling personnel), each key region including at least two vertexes; performs screening processing on vertexes in each key region, to obtain P key vertex sets; and generates the vertex relationship indication information based on the P key vertex sets. That a vertex A and a vertex B have a constraint relationship may be understood as that the vertex A and the vertex B are different key vertexes in a same key vertex set (where the vertex A and the vertex B belong to a same key region), and a difference between a skin weight of the vertex A and a skin weight of the vertex B is less than a difference threshold.

(3) A skin weight prediction model of the computer device 101 is configured to predict a skin weight of the mesh model based on the vertex relationship indication information, the vertex features, and the topology information of the mesh model, the skin weight of the mesh model being configured for indicating a deformation influence degree of the joint point of the object on each vertex in the mesh model in a deformation process of the mesh model. In an implementation, the computer device may perform conversion on the vertex relationship indication information, the vertex features, and the topology information of the mesh model, to obtain model input features of the skin weight prediction model, which may specifically include basic features (Basic features), for example, a location of a vertex, a normal vector of the vertex, and a distance between the vertex and the joint point; a neighbor feature (hint neighbor matrix), for example, a neighbor matrix of the mesh model; and an aggregation feature (hint attention weights), for example, a feature obtained by aggregating features of vertexes. The neighbor feature and the aggregation feature are two features having an inner and outer layer skin weight similarity constraint.

In an implementation, the skin weight prediction model includes a neural network layer and M feature fusion modules, M being a positive integer. The computer device 101 invokes the M feature fusion modules to perform feature fusion processing on the vertex relationship indication information and the vertex feature of each vertex in the mesh model, to obtain fusion features of the vertexes. Specifically, the computer device 101 uses the vertex relationship indication information as constraint information, constrains a transformation process of the vertex feature of each vertex by using the constraint information (for example, causing a difference between transformation features of vertexes having the constraint relationship to be less than a feature difference threshold), to obtain a transformation feature of each vertex, and then performs feature concatenation processing on the transformation feature of each vertex and the vertex feature of the vertex, to obtain the fusion feature of each vertex. After the fusion features of the vertexes are obtained, the computer device 101 performs, by using the neural network layer, mapping processing on the fusion features of the vertexes and the topology information of the mesh model, to obtain the skin weight of the mesh model.

In this embodiment of this application, vertex features of vertexes in a mesh model of an object and topology information of the mesh model are obtained; and vertex relationship indication information is obtained, the vertex relationship indication information being configured for indicating vertexes having a constraint relationship in the mesh model, and the constraint relationship being a constraint relationship between two different vertexes. A skin weight prediction model is configured to predict a skin weight of the mesh model based on the vertex relationship indication information, the vertex features, and the topology information of the mesh model. It can be seen that, in a process of predicting the skin weight of the mesh model, skin weights of the vertexes in the mesh model are constrained by using the vertex relationship indication information, so that accuracy of predicting a skinning matrix of the mesh model can be improved.

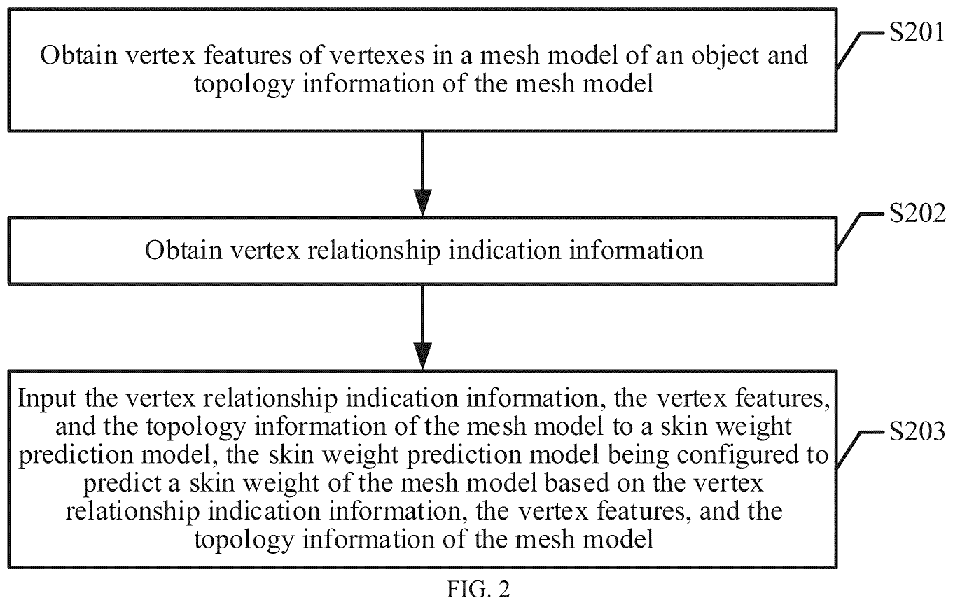

FIG. 2 is a flowchart of an image processing method according to an embodiment of this application. The image processing method may be performed by a computer device, and the computer device may be specifically a terminal device or a server. As shown in FIG. 2, the image processing method may include the following operation S201 to operation S203.

S201: Obtain vertex features of vertexes in a mesh model of an object and topology information of the mesh model.

The vertex feature of each vertex in the mesh model of the object includes at least one of the following: location information of the vertex (for example, a location of the vertex in a Cartesian coordinate system), a normal vector of the vertex, and a second distance (for example, a Euclidean distance) between the vertex and each joint point of the object.

In an implementation, the computer device obtains the location information and the normal vector of each vertex in the mesh model of the object, and calculates the second distance (for example, the Euclidean distance) between the vertex and each joint point of the object based on the location information of the vertex. Next, the computer device combines the location information and the normal vector of each vertex with the second distance between the vertex and each joint point of the object, to obtain the vertex feature of the vertex.

The topology information of the mesh model may be configured for indicating a location relationship between a joint point of the object and each vertex in the mesh model and a connection relationship between the vertexes in the mesh model. The topology information of the mesh model includes a vertex graph topology structure of the mesh model of the object and a joint point graph topology structure of the object. The vertex graph topology structure of the mesh model of the object includes at least one of the following: the vertexes in the mesh model of the object, connecting edges between the vertexes in the mesh model of the object, and a neighbor matrix of the vertexes connecting edge in the mesh model of the object. In an implementation, the computer device performs topology graph information extraction processing on the mesh model of the object, to obtain the topology information of the mesh model.

S202: Obtain vertex relationship indication information.

The vertex relationship indication information is configured for indicating vertexes having a constraint relationship in the mesh model, and the constraint relationship is a constraint relationship between two different vertexes.

In an implementation, the joint point of the object includes at least one basic (general) joint point and P additional joint points corresponding to the mesh model, P being a positive integer. For different mesh models of the same object (for example, different costumes of a same virtual character), basic joint point of the mesh models are the same, and additional joint points of the mesh models may be different. The computer device obtains P key regions in a one-to-one correspondence with the P additional joint points in the mesh model (where the key regions may be indicated by a modeling personnel), each key region including at least two vertexes; performs screening processing on vertexes in each key region, to obtain P key vertex sets; and generates the vertex relationship indication information based on the P key vertex sets. That a vertex A and a vertex B have a constraint relationship may be understood as that the vertex A and the vertex B are different key vertexes in a same key vertex set (where the vertex A and the vertex B belong to a same key region), and a difference between a skin weight of the vertex A and a skin weight of the vertex B is less than a difference threshold.

In an embodiment, a process in which the computer device performs screening processing on the vertexes in each key region, to obtain the P key vertex sets includes: A q^{th} key region is any one of the P key regions, the q^{th} key region corresponds to a q^{th} additional joint point in the P additional joint points, and a target vertex having a shortest second distance (a Euclidean distance) with the q^{th} additional joint point in the q^{th} key region and neighborhood vertexes of the target vertex are added to a candidate vertex set. The neighborhood vertexes of the target vertex are vertexes within S hops with the target vertex (that is, vertexes that can reach the vertex A through at least S connecting edges that are not repeated and cannot form a loop), q is a positive integer less than or equal to P, and S is a positive integer (specifically, dynamical adjustment may be performed based on an actual case).

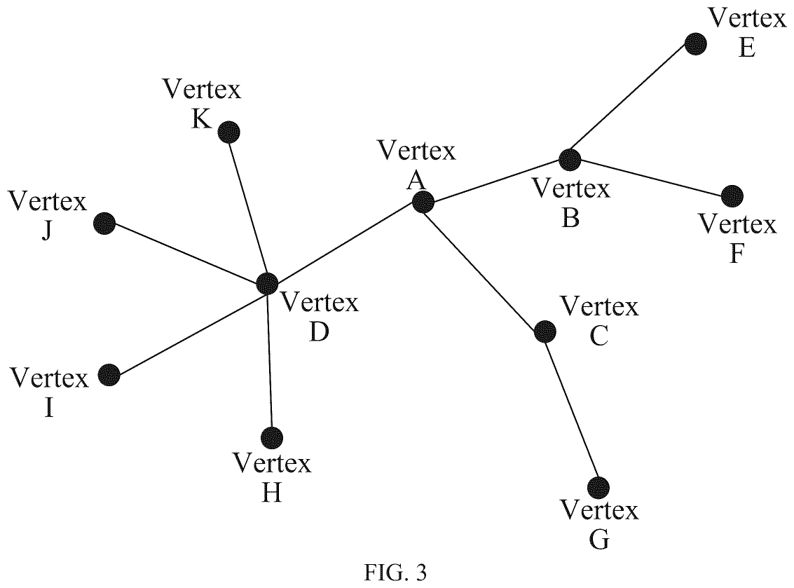

FIG. 3 is a schematic diagram of neighborhood vertexes according to an embodiment of this application. As shown in FIG. 3, a vertex A is separately connected to a vertex B, a vertex C, and a vertex D (there are connecting edges separately between the vertex A and the vertex B, the vertex C, and the vertex D). In this case, one-hop neighborhood vertexes of the vertex A include the vertex B, the vertex C, and the vertex D (that is, vertexes that can reach the vertex A through at least one connecting edge). Similarly, a vertex E and a vertex F are indirectly connected to the vertex A through the vertex B, a vertex G is indirectly connected to the vertex A through the vertex C, and a vertex H, a vertex I, a vertex J, and a vertex K are indirectly connected to the vertex A through the vertex D. Second-hop neighborhood vertexes of the vertex A include: the vertex E, the vertex F, the vertex G, the vertex H, the vertex I, the vertex J, and the vertex K (that is, vertexes that can reach the vertex A through at least two connecting edges that are not repeated and cannot form a loop).

Further, the computer device obtains marked weights of candidate vertexes in the candidate vertex set and marked weights of neighborhood vertexes of each candidate vertex, and performs mean processing on differences between the marked weight of each candidate vertex and the marked weights of the neighborhood vertexes of the candidate vertex in the candidate vertex set, to obtain a difference mean corresponding to each candidate vertex. The marked weight of each candidate vertex is configured for indicating a deformation influence degree of the q^{th} additional joint point on the candidate vertex in a deformation process of the mesh model of the object. The marked weight of the neighborhood vertex of each candidate vertex is configured for indicating an influence weight of the q^{th} additional joint point to the neighborhood vertex in the deformation process of the mesh model of the object.

For example, it is assumed that a marked weight of a candidate vertex A is 0.22, neighborhood vertexes of the candidate vertex A include a vertex B and a vertex C, a marked weight of the vertex B is 0.19, and a marked weight of the vertex C is 0.24. In this case, a difference between the marked weight of the candidate vertex A and the marked weight of the vertex B is that 10.22−0.19|=0.03, a difference between the marked weight of the candidate vertex A and the marked weight of the vertex C is that 10.22−0.24|=0.02, and a difference mean corresponding to the candidate vertex A is that (0.03+0.02)/2=0.025.

After the difference mean corresponding to each candidate vertex is obtained, the computer device determines a candidate vertex having a largest difference mean as a representative vertex of the candidate vertex set, and adds a first vertex in the ql key region to a ql key vertex set (where key vertexes in the key vertex sets are vertexes in the mesh model). A difference between a difference mean of the first vertex and the difference mean of the representative vertex is less than a mean threshold. The ql key region corresponds to the q^{th} key vertex set in the P key vertex sets. For example, it is assumed that the candidate vertex set includes a candidate vertex A, a candidate vertex B, and a candidate vertex C, a difference mean corresponding to the candidate vertex A is 0.31, a difference mean corresponding to the candidate vertex B is 0.35, and a difference mean corresponding to the candidate vertex C is 0.28. In this case, the candidate vertex B is the representative vertex of the candidate vertex set. It is assumed that the q^{th} key region further includes a vertex E, a vertex F, a vertex G, and a vertex H in addition to the candidate vertex A, the candidate vertex B, and the candidate vertex C, a difference mean corresponding to the vertex E is 0.32, a difference mean corresponding to the vertex F is 0.21, a difference mean corresponding to the vertex G is 0.29, a difference mean corresponding to the vertex H is 0.3, and the mean threshold is 0.08. In this case, the first vertex added to the q^{th} key vertex set includes the candidate vertex A, the candidate vertex B, the candidate vertex C, the vertex E, the vertex G, and the vertex H.

S203: Input the vertex relationship indication information, the vertex features, and the topology information of the mesh model to a skin weight prediction model, the skin weight prediction model being configured to predict a skin weight of the mesh model based on the vertex relationship indication information, the vertex features, and the topology information of the mesh model.

The skin weight of the mesh model includes a skin weight of a joint point to each vertex in the mesh model, and the skin weight is a value. The skin weight of the mesh model is configured for indicating a deformation influence degree of the joint point of the object on each vertex in the mesh model in the deformation process of the mesh model. The deformation influence degree may be quantized by using a value of the skin weight. The deformation influence degree is in positive correlation with the value of the skin weight. A larger value of the skin weight indicates a larger deformation influence degree of the joint point of the object on each vertex in the mesh model in the deformation process of the mesh model, and a smaller value of the skin weight indicates a smaller deformation influence degree of the joint point of the object on each vertex in the mesh model in the deformation process of the mesh model. For example, a skin weight of a joint point 1 to a vertex 1 is greater than a skin weight of the joint point 1 to a vertex 2. In this case, in the deformation process of the mesh model, a deformation influence degree of the joint point 1 on the vertex 1 is greater than a deformation influence degree of the joint point 1 on the vertex 2. If deformation of the joint point 1 means that a location of the joint point 1 changes, a location change amount of the vertex 1 following the joint point 1 is greater than a location change amount of the vertex 2 following the joint point 1.

In an implementation, the skin weight prediction model includes a neural network layer and M feature fusion modules, M being a positive integer. The computer device invokes the M feature fusion modules to perform feature fusion processing on the vertex relationship indication information and the vertex feature of each vertex in the mesh model, to obtain fusion features of the vertexes. The feature fusion processing is performing, after a transformation feature of each vertex in the mesh model is obtained by performing transformation on the vertex feature of each vertex in the mesh model based on the vertex relationship indication information, concatenation processing on the transformation feature of each vertex in the mesh model and the vertex feature of each vertex in the mesh model. Specifically, the computer device uses the vertex relationship indication information as constraint information, constrains a transformation process of the vertex feature of each vertex by using the constraint information (for example, causing a difference between transformation features of vertexes having the constraint relationship to be less than a feature difference threshold), to obtain the transformation feature of each vertex, and then performs feature concatenation processing on the transformation feature of each vertex and the vertex feature of the vertex, to obtain the fusion feature of each vertex. Next, the computer device performs, by using the neural network layer, mapping processing on the fusion features of the vertexes and the topology information of the mesh model, to obtain the skin weight of the mesh model.

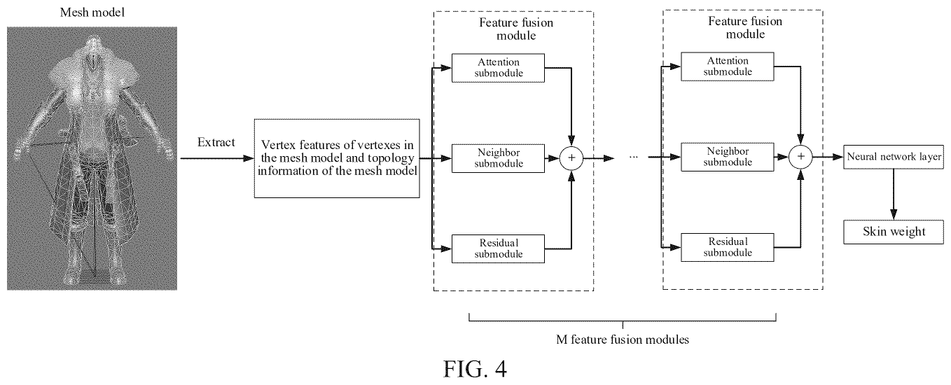

FIG. 4 is a schematic diagram of an architecture of a skin weight prediction model according to an embodiment of this application. As shown in FIG. 4, the skin weight prediction model includes a neural network layer and M feature fusion modules. An output of an it feature fusion module is an input of an (i+1)^{th} fusion module, and i is a positive integer less than M. An input of a first feature fusion module includes the vertex features of the vertexes in the mesh model of the object and the topology information of the mesh model. After the fusion features of the vertexes in the mesh model of the object are obtained by using the M feature fusion modules (where in the process, a constraint may be performed based on the vertex relationship indication information), mapping processing is performed on the fusion features of the vertexes by using the neural network layer (for example, a multilayer perceptron (MLP)), to obtain the skin weight of the mesh model.

In an embodiment, the vertex relationship indication information includes the P key vertex sets (weight hints vertex sets), where the key vertexes (Hint vertexes) in the key vertex sets are vertexes in the mesh model, and P is a positive integer. Each feature fusion module includes an attention submodule (Hints Attention), a residual submodule (Residual Vertex), and a neighbor submodule (Hints Neighbor). The neighbor submodule is configured to determine a neighborhood feature of each vertex based on the vertex features of the vertexes. The attention submodule is configured to aggregate the vertex features of the vertexes into the P key vertex sets, to obtain P aggregation features. The residual submodule is configured to extract deep features of the vertexes based on the vertex features of the vertexes. A process in which the computer device invokes the M feature fusion modules to perform feature fusion processing on the vertex relationship indication information and the vertex features of the vertexes in the mesh model, to obtain the fusion features of the vertexes is as follows:

In an aspect, the computer device obtains P first neighbor matrices corresponding to the P key vertex sets. In an embodiment, the computer device establishes connecting edges between key vertexes in each key vertex set. After the connecting edges between the key vertexes in each key vertex set are established, the computer device obtains the P first neighbor matrices corresponding to the P key vertex sets based on a connection relationship between the key vertexes in the P key vertex sets. After the connecting edges between the key vertexes in each key vertex set are established, there are connecting edges between any key vertex and remaining key vertexes in each key vertex set. For example, assuming that the q^{th} key vertex set includes a key vertex 1 to a key vertex 5, there are connecting edges between the key vertex 1 and the key vertex 2 to the key vertex 5.

Further, the computer device performs, by using the neighbor submodule (Hints Neighbor), feature conversion processing on the P first neighbor matrices and the vertex features of the vertexes, to obtain the neighborhood features of the vertexes. Specifically, the computer device determines, by using a q^{th} first neighbor matrix, k neighboring vertexes of a key vertex j, the ql first neighbor matrix being a first neighbor matrix of the q^{th} key vertex set, the key vertex j belonging to the ql key vertex set, and k being a positive integer. After the k neighboring vertexes of the key vertex j are determined, a difference between a vertex feature of the key vertex j and a vertex feature of each neighboring vertex in the k neighboring vertexes is respectively calculated, to obtain k difference features, and a largest value in the k difference features is determined as a neighborhood feature of the key vertex j.

In another aspect, the computer device invokes the attention submodule (Hints Attention) to aggregate the vertex features of the vertexes in the mesh model into the key vertex sets, to obtain the P aggregation features. The P aggregation features are in a one-to-one correspondence with the P key vertex sets, and a q^{th} aggregation feature is configured for indicating a similarity between a skin weight of a vertex in the mesh model and a skin weight of each key vertex in the q^{th} key vertex set. A specific implementation in which the computer device invokes the attention submodule to aggregate the vertex features of the vertexes in the mesh model into the key vertex sets, to obtain the q^{th} aggregation features includes: obtaining q^{th} weights corresponding to the vertexes in the mesh model, q being a positive integer less than or equal to P; performing, by using the q^{th} weight corresponding to each vertex, weighting processing on the vertex feature of the vertex, to obtain weighted features of the vertexes; and performing aggregation processing on the weighted features of the vertexes, to obtain the q^{th} aggregation feature.

In still another aspect, the computer device performs, by using the residual submodule (Residual Vertex), deep feature extraction processing on the vertex features of the vertexes, to obtain the deep features of the vertexes.

After the neighborhood feature of each vertex, the P aggregation features, and the deep feature of each vertex are obtained, the computer device performs concatenation processing on the neighborhood feature of each vertex, the P aggregation features, and the deep feature of each vertex, to obtain the fusion features of the vertexes in the mesh model of the object.

In another implementation, the object includes N joint points, N being a positive integer. The computer device invokes the skin weight prediction model to predict N predicted weights of each vertex in the mesh model based on the vertex relationship indication information, the vertex features, and the topology information of the mesh model, the N joint points of the object being in a one-to-one correspondence with the N predicted weights. For a vertex h, a predicted weight outputted by the skin weight prediction model may be recorded as: wᵢ∈ [symbol] ^{B}, B is a quantity of joint points. wₕᵤ is a u^{th} predicted weight of the vertex h, where the u^{th} predicted weight of the vertex h is configured for indicating a deformation influence degree of a joint point u on the vertex h in the deformation process of the mesh model. The vertex h is any vertex in the mesh model, the u^{th} predicted weight corresponds to the joint point u, and u is a positive integer less than or equal to N. 0≤wₕᵤ≤1, and wₕᵤ=1.

$${\sum }_{u}^{B} {w}_{hu} = 1 .$$

After the N predicted weights of each vertex are obtained, the computer device selects R (for example, R=3) largest predicted weights from the N predicted weights of each vertex, uses the R largest predicted weights as R key weights of each vertex, and performs normalization processing on the R key weights of each vertex, to obtain the skin weight of the mesh model, and R is an integer greater than 1 and less than or equal to N. In this implementation, sparsity of the skin weight of the mesh model can be further enhanced, and accuracy of a weight prediction result can be improved.

For example, it is assumed that the object includes four joint points, and the computer device invokes the skin weight prediction model to perform skin weight prediction processing based on the vertex relationship indication information, the vertex features, and topology information of the mesh model, to obtain four predicted weights of the vertex h in the mesh model of the object. A predicted weight of a joint point 1 is 0.5, a predicted weight of a joint point 2 is 0.3, a predicted weight of a joint point 3 is 0.15, and a predicted weight of a joint point 4 is 0.05. If R=2, the computer device reserves the predicted weight of the joint point 1 and the predicted weight of the joint point 2 (and performs zero setting processing on the predicted weight of the joint point 3 and the predicted weight of the joint point 4), and performs normalization processing on the predicted weight of the joint point 1 and the predicted weight of the joint point 2, to obtain a first skin weight of the vertex h (configured for indicating a deformation influence degree of the joint point 1 on the vertex h in the deformation process of the mesh model) as 0.625 and a second skin weight of the vertex h (configured for indicating a deformation influence degree of the joint point 2 on the vertex h in the deformation process of the mesh model) as 0.375. A third skin weight of the vertex h (configured for indicating a deformation influence degree of the joint point 3 on the vertex h in the deformation process of the mesh model) and a fourth skin weight of the vertex h (configured for indicating a deformation influence degree of the joint point 4 on the vertex h in the deformation process of the mesh model) are both 0.

In this embodiment of this application, vertex features of vertexes in a mesh model of an object and topology information of the mesh model are obtained; and vertex relationship indication information is obtained, the vertex relationship indication information being configured for indicating vertexes having a constraint relationship in the mesh model, and the constraint relationship being a constraint relationship between two different vertexes. A skin weight prediction model is configured to predict a skin weight of the mesh model based on the vertex relationship indication information, the vertex features, and the topology information of the mesh model. It can be seen that, in a process of predicting the skin weight of the mesh model, skin weights of the vertexes in the mesh model are constrained by using the vertex relationship indication information, so that accuracy of predicting a skinning matrix of the mesh model can be improved. In addition, feature conversion processing is performed on P first neighbor matrices and the vertex features of the vertexes by using a neighbor submodule, so that key vertex sets may be added to a second neighbor matrix, to aggregate neighborhood vertex features in the mesh model (for example, different layers of meshes), thereby constraining the skin weights of the vertexes. Deep feature extraction processing is performed on the vertex features of the vertexes by using a residual submodule, so that deep features (features at a deeper level) of the vertexes in the mesh model may be effectively extracted, thereby further improving prediction accuracy of the skin weight prediction model. An attention submodule is invoked to aggregate the vertex features of the vertexes in the mesh model into key vertex sets, so that the vertex features of the vertexes in the mesh model may be aggregated into P key vertex sets according to an adaptive weight, and vertex features of key vertexes in the P key vertex sets may also be effectively transferred to remaining vertexes (non-key vertexes) in the mesh model.

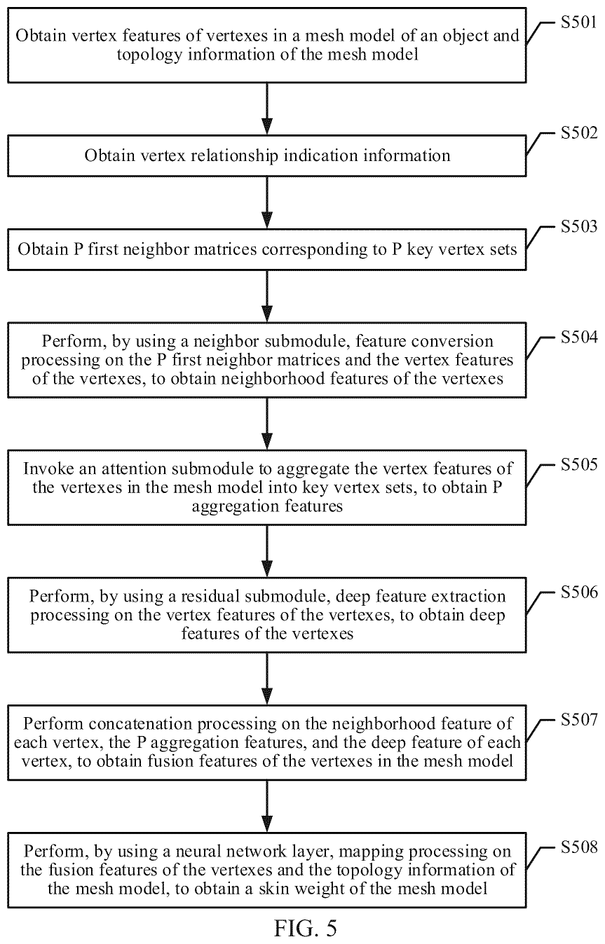

FIG. 5 is a flowchart of another image processing method according to an embodiment of this application. The image processing method may be performed by a computer device, and the computer device may be specifically a terminal device or a server. As shown in FIG. 5, the image processing method may include the following operation S501 to operation S508.

S501: Obtain vertex features of vertexes in a mesh model of an object and topology information of the mesh model.

The vertex feature of each vertex in the mesh model of the object includes at least one of the following: location information of the vertex, a normal vector of the vertex, and a second distance (for example, a Euclidean distance) between the vertex and each joint point of the object. In an implementation, a vertex feature of a vertex h may be represented by using a feature vector, and may be specifically represented as:

$${v}_{h} = [ {p}_{h}^{T} , {n}_{h}^{T} , {e}_{h}^{T} ]$$

$${p}_{h}^{T}$$

is configured for representing a location of the vertex h in a Cartesian coordinate system, and

$${p}_{h}^{T} ∈ {ℛ}^{3} . {p}_{h}^{T}$$

may be represented by using a three-dimensional vector (pₕₓ, p_{hy}, p_{hz}), where pₕₓ represents an x-axis coordinate of the vertex h in the Cartesian coordinate system, p_{hy} represents a y-axis coordinate of the vertex h in the Cartesian coordinate system, and p_{hz} represents a z-axis coordinate of the vertex h in the Cartesian coordinate system.

$${n}_{h}^{T}$$

is configured for representing a normal vector of the vertex h, and

$${n}_{h}^{T} ∈ {R}^{3} . {n}_{h}^{T}$$

may be represented by using a three-dimensional vector (nₕₓ, n_{hy}, n_{hz}).

$${e}_{h}^{T}$$

is configured for representing a Euclidean distance between the vertex h and each joint point of an object. If the object includes B joint points (in other words,

$${e}_{h}^{T}$$

has |B| dimensions in total),

$${e}_{i}^{T} ∈ {ℛ}^{\vert B \vert} .$$

Further, in the foregoing vector representation manner of the vertex feature, dimensions of vertex features of N vertexes may be represented as: (N, 6+|B|)

N is a total quantity of the vertexes in the mesh model of the object, and 6+|BI is a dimension of a feature vector of each vertex.

The topology information of the mesh model includes a vertex graph topology structure of the mesh model of the object and a joint point graph topology structure of the object, and may be specifically represented as:

$$G = ( {G}_{m} , {G}_{j} )$$

Gₘ is the vertex graph topology structure of the mesh model (mesh) of the object. Gₘ may further be expressed as Gₘ=(Vₘ, εₘ, Aₘ), where Vₘ represents a vertex in the mesh model of the object, εₘ 9V×V represents a connecting edge in the mesh model of the object, Aₘ is a vertex neighbor matrix that is formed by a value of (0, 1) and that has a size of N×N. N is the total quantity of the vertexes in the mesh model of the object. A connection relationship between the vertexes in the mesh model may be represented by using the vertex neighbor matrix Aₘ, and Aₘ may be configured for indicating connectivity between a vertex pair (that is, two vertexes) in the mesh model of the object. If Aₘ(i,j)=1, it indicates that there is a connecting edge between a vertex i and a vertex j. If Aₘ(i,j)=0, it indicates that there is no connecting edge between the vertex i and the vertex j. For any vertex i in the mesh model of the object, a neighbor node set of the vertex i may be represented by using Ni. For example, a one-hop neighbor node of the vertex i includes a vertex in the mesh model of the object that has a connecting edge with the vertex i (that is, the vertex is directly connected to the vertex i).

S502: Obtain vertex relationship indication information.

In an implementation, the joint point of the object includes at least one basic (general) joint point and P additional joint points corresponding to the mesh model, P being a positive integer. For different mesh models of the same object (for example, different costumes of a same virtual character), basic joint points of the mesh models are the same, and additional joint points of the mesh models may be different. Detailed descriptions are made by using an example of determining a key vertex set (weight hints vertex set) corresponding to a q^{th} additional joint point.

(1) The computer device obtains a key region corresponding to the q^{th} additional joint point (where the key region may be indicated by a modeling personnel), and calculates a Euclidean distance between each vertex in the key region corresponding to the q^{th} additional joint point and the q^{th} additional joint point. A target vertex (for example, vᵢ) in the q^{th} key region and neighborhood vertexes of the target vertex are added to a candidate vertex set, to obtain the candidate vertex set (for example, Cᵢ). A second distance (a Euclidean distance) between the target vertex and the q^{th} additional joint point is less than a second distance (a Euclidean distance) between another vertex other than the target vertex in the q^{th} key region and the q^{th} additional joint point. In other words, in the q^{th} key region, the target vertex has a shortest (Euclidean) distance with the q^{th} additional joint point.

(2) The computer device respectively calculates marked weight differences between each candidate vertex in the candidate vertex set and neighbor vertexes (that is, vertexes within a neighborhood) of the candidate vertex, and calculates a difference mean corresponding to each candidate vertex based on the marked weight differences between each candidate vertex and the neighbor vertexes of the candidate vertex. Specifically, the computer device obtains marked weights of candidate vertexes in the candidate vertex set and marked weights of neighborhood vertexes of each candidate vertex, and performs mean processing on differences between the marked weight of each candidate vertex in the candidate vertex set and the marked weights of the neighborhood vertexes of the candidate vertex, to obtain a difference mean corresponding to each candidate vertex. The marked weight of each candidate vertex is configured for indicating a deformation influence degree of the q^{th} additional joint point on the candidate vertex in a deformation process of the mesh model of the object. The marked weight of the neighborhood vertex of each candidate vertex is configured for indicating an influence weight of the q^{th} additional joint point to the neighborhood vertex in the deformation process of the mesh model of the object. A difference mean corresponding to a candidate vertex j may be represented as:

$${d}_{j} = \frac{1}{m} {\sum }_{k = 0}^{m} \vert {weights}_{j} - {weights}_{k} \vert$$

dⱼ represents the difference mean corresponding to the candidate vertex j, and m is a quantity of neighbor nodes (that is, vertexes within a neighborhood) of the candidate vertex j; and weightsᵢ represents a marked weight of the candidate vertex j, and weightsₖ represents a marked weight of a neighbor node of the candidate vertex j.

(3) After the difference mean corresponding to each candidate vertex is obtained, the computer device determines a candidate vertex having a largest difference mean as a representative vertex of the candidate vertex set. For example, it is assumed that the candidate vertex set includes a candidate vertex A, a candidate vertex B, and a candidate vertex C, a difference mean corresponding to the candidate vertex A is 0.31, a difference mean corresponding to the candidate vertex B is 0.35, and a difference mean corresponding to the candidate vertex C is 0.28. In this case, the candidate vertex B is the representative vertex of the candidate vertex set.

(4) The computer device adds a first vertex in the key region corresponding to the q^{th} additional joint point (that is, the q^{th} key region) to a q^{th} key vertex set, a difference between a difference mean of the first vertex and the difference mean of the representative vertex being less than a mean threshold. For example, it is assumed that the candidate vertex B in the candidate vertex set is the representative vertex of the candidate vertex set (where the difference mean corresponding to the candidate vertex B is 0.35). It is assumed that the q^{th} key region includes a vertex E, a vertex F, a vertex G, and a vertex H, a difference mean corresponding to the vertex E is 0.32, a difference mean corresponding to the vertex F is 0.21, a difference mean corresponding to the vertex G is 0.29, a difference mean corresponding to the vertex H is 0.3, and a mean threshold is 0.08. In this case, the q^{th} key vertex set includes the vertex E, the vertex G, and the vertex H.

According to the foregoing procedure of determining a key vertex set, the computer device may obtain key vertex sets corresponding to the additional joint points, and generate the vertex relationship indication information according to key vertex sets corresponding to the P additional joint points.

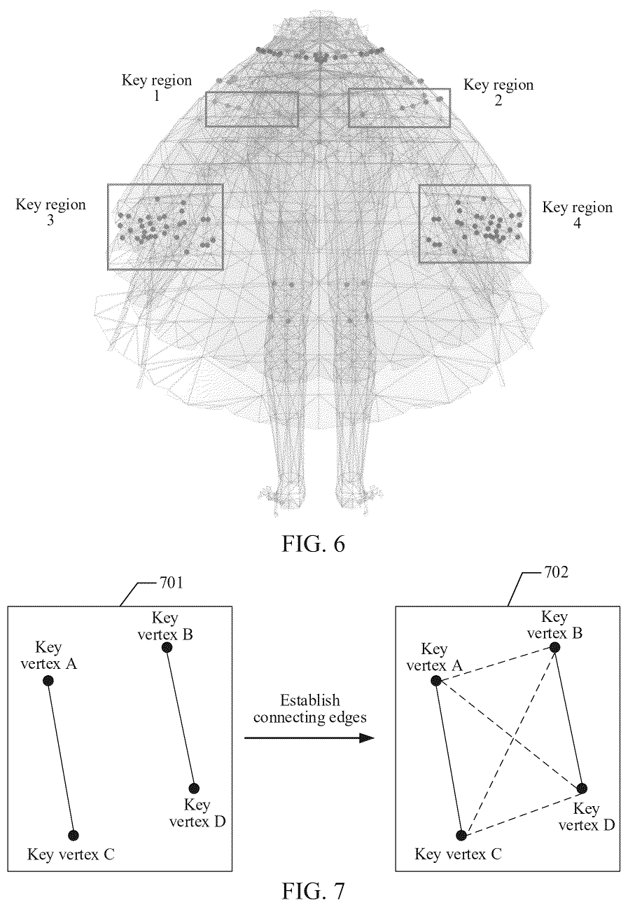

FIG. 6 is a schematic diagram of key vertexes according to an embodiment of this application. As shown in FIG. 6, the mesh model of the object in the schematic diagram includes four key regions, in other words, the mesh model of the object corresponds to four additional joint points. Bold vertexes in each key region are key vertexes that are determined according to the foregoing implementation and that belong to a same key vertex set. A shape of the key region is merely an example and does not constitute an actual limitation of this application. For example, the shape of the key region may alternatively be a circle, another polygon, or the like.

The modeling personnel may also directly indicate a key vertex set corresponding to each additional joint point.

S503: Obtain P first neighbor matrices corresponding to P key vertex sets.

In an implementation, the computer device establishes connecting edges between key vertexes in each key vertex set, and obtains the P first neighbor matrices corresponding to the P key vertex sets based on the mesh model after the connecting edges are established. In an embodiment, if there is no connecting edge between a key vertex i and a key vertex j in the q^{th} key vertex set, the computer device establishes a connecting edge between the key vertex i and the key vertex j, where q is a positive integer less than or equal to P, and the key vertex i and the key vertex j are any two key vertexes in the ql key vertex set.

After the connecting edges between the key vertexes in each key vertex set are established, any key vertex in each key vertex set and other key vertexes in the key vertex set are neighbor vertexes.

FIG. 7 is a schematic diagram of establishing connecting edges between key vertexes according to an embodiment of this application. As shown in FIG. 7, it is assumed that a key vertex set includes a key vertex A, a key vertex B, a key vertex C, and a key vertex D. As shown in 701, before connecting edges are established, there is a connecting edge between the key vertex A and the key vertex C, and there is a connecting edge between the key vertex B and the key vertex D. As shown in 702, after the connecting edges are established (dashed edges are newly added connecting edges), any one of the key vertex A, the key vertex B, the key vertex C, and the key vertex D has a connecting edge with each of the remaining three key vertexes.

In actual application, connecting edges between key vertexes are established, so that a neighbor relationship may be established for vertexes having a constraint relationship in the mesh model (for example, vertexes corresponding to inner and outer clothes), thereby improving, in a subsequent process of predicting a skin weight, a capability of learning a skin weight similarity feature of the vertexes having the constraint relationship in the mesh model by a skin weight prediction model.

S504: Perform, by using a neighbor submodule, feature conversion processing on the P first neighbor matrices and the vertex features of the vertexes, to obtain neighborhood features of the vertexes.

In an implementation, a process in which the computer device performs, by using the neighbor submodule, feature conversion processing on the P first neighbor matrices and the vertex features of the vertexes, to obtain the neighborhood features of the vertexes includes: determining, by using a q^{th} first neighbor matrix, k neighboring vertexes of a key vertex j, the ql first neighbor matrix being a first neighbor matrix of the ql key vertex set, the key vertex j belonging to the q^{th} key vertex set, and k being a positive integer. Specifically, the topology information of the mesh model includes a second neighbor matrix (that is, Aₘ in operation S501), and the second neighbor matrix is obtained based on a connection relationship between the vertexes in the mesh model (before the connecting edges between the key vertexes in each key vertex set are established). In other words, the second neighbor matrix may be configured for indicating the connection relationship between the vertexes in the mesh model. The computer device determines, by using the q^{th} first neighbor matrix, T key vertexes having connecting edges with the key vertex j, T being a positive integer. If T is greater than or equal to k, the computer device randomly selects k vertexes from the T key vertexes as the k neighboring vertexes of the key vertex j. Correspondingly, if T is less than k, the computer device determines, by using the second neighbor matrix, V vertexes having connecting edges with the key vertex j, randomly selects (k−T) vertexes from the V vertexes, and uses the T key vertexes and the selected (k−T) vertexes as the k neighboring vertexes of the key vertex j, V being a positive integer.

After the k neighboring vertexes of the key vertex j are determined, the computer device respectively calculates a difference between a vertex feature of the key vertex j and a vertex feature of each neighboring vertex in the k neighboring vertexes, to obtain k difference features. The k difference features may be specifically represented as:

$$\{ {x}_{j 1} - {x}_{j} , {x}_{j 2} - {x}_{j} … , {x}_{jk} - {x}_{j} \}$$

xⱼₖ−xⱼ represents a difference between the vertex feature of the key vertex j and a vertex feature of a k* neighboring vertex of the key vertex j, which may be recorded as h(xⱼ, xⱼₖ). In other words, h(xⱼ, xⱼₖ)−(xⱼₖ−xⱼ)·{xⱼ₁, xⱼ₂ . . . , xⱼₖ} is vertex features of the k neighboring vertexes of the key vertex j.

Further, the computer device determines a largest value in the k difference features as a neighborhood feature of the key vertex j.

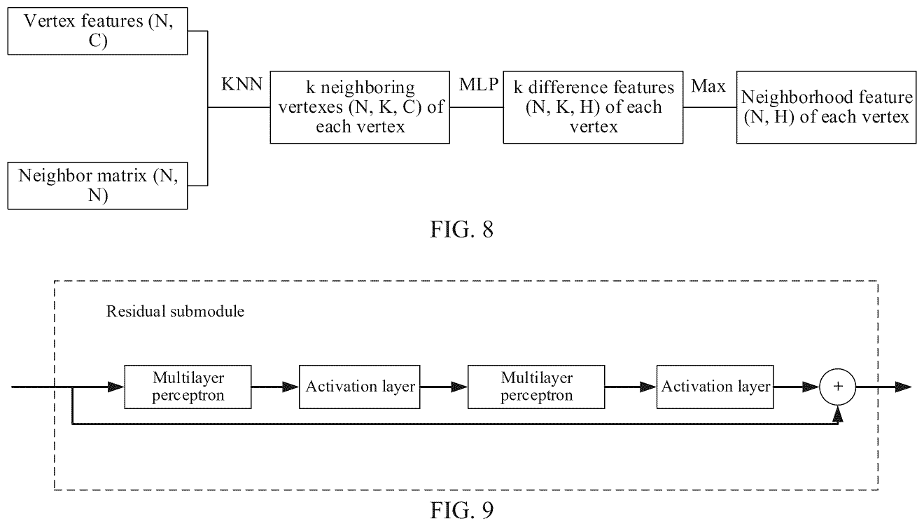

FIG. 8 is a schematic diagram of feature conversion of a neighbor submodule according to an embodiment of this application. As shown in FIG. 8, the computer device first determines k neighboring vertexes of each vertex by using the vertex features of the vertexes in the mesh model and a neighbor matrix (including at least one of a first neighbor matrix and a second neighbor matrix) of the vertexes (for example, by using a k-nearest neighbor (KNN) algorithm). The vertex features of the vertexes in the mesh model are represented as (N, C), where N is a quantity of the vertexes, and C is the vertex features. The neighbor matrix of the mesh model is represented as (N, N), where N is the quantity of the vertexes. (N, K, C) includes the vertex feature of each vertex and the k neighboring vertexes of each vertex. Then, feature transformation is performed by using a fully-connected multilayer perceptron (MLLP) based on the vertex feature of each vertex and vertex features of the k neighboring vertexes of the vertex, to obtain k difference features of each vertex. (N, K, H) includes the difference feature between the vertex feature of each vertex and the vertex features of the k neighboring vertexes of the vertex. A largest difference feature in the k difference features of each vertex is reserved, to obtain the neighborhood feature of each vertex represented as (N, H).

Feature conversion processing is performed on the P first neighbor matrices and the vertex features of the vertexes by using the neighbor submodule, to obtain the neighborhood features of the vertexes, so that the key vertex sets may be added to a second neighbor matrix, to aggregate neighborhood vertex features in the mesh model (for example, different layers of meshes), thereby constraining the skin weight of the vertexes (that is, making vertex features of the vertexes having the constraint relationship as similar as possible).

S505: Invoke an attention submodule to aggregate the vertex features of the vertexes in the mesh model into the key vertex sets, to obtain P aggregation features.

The P aggregation features are in a one-to-one correspondence with the P key vertex sets, a q^{th} aggregation feature is configured for indicating similarity between a skin weight of a vertex in the mesh model and a skin weight of each key vertex in the q^{th} key vertex set, and q is a positive integer less than or equal to P.

In an implementation, a process in which the computer device invokes the attention submodule to aggregate the vertex features of the vertexes in the mesh model into the key vertex sets, to obtain the P aggregation features includes: obtaining q^{th} weights corresponding to the vertexes in the mesh model, q being a positive integer less than or equal to P. Specifically, a process in which the computer device obtains the q^{th} weights corresponding to the vertexes in the mesh model includes: performing mean processing on first distances between the key vertexes in the q^{th} key vertex set and a vertex h, to obtain an average shortest distance between the vertex h and the q^{th} key vertex set (where each key vertex set is configured as a whole, and the q^{th} key vertex set is represented as Gq) (that is, a q^{th} distance mean corresponding to the vertex h), the vertex h being any vertex in the mesh model. In an embodiment, a first distance between the key vertex j and the vertex h in the q^{th} key vertex set is a shortest distance (which may be obtained through calculation by using a Dijkstra algorithm) from the key vertex j to the vertex h through a connecting edge in the mesh model. The q^{th} distance mean corresponding to the vertex h may be represented as:

$${hint\_dist}_{q h} = \frac{1}{m} {\sum }_{q = 0}^{m} dijkstra ( {v}_{q} , {v}_{h} )$$

hint_dist_{qh} represents the q^{th} distance mean of the vertex h (which may be understood as that distances between key vertexes in the q^{th} key vertex set and the vertex h are all hint_dist_{qh}); and m is a quantity of the key vertexes in the q^{th} key vertex set, and dijkstra(v_{q}, vₕ) represents a shortest distance between the vertex h and a key vertex q in the q^{th} key vertex set in the mesh model.

Further, the computer device determines a q^{th} weight of the vertex h based on a derivation result of the q^{th} distance mean corresponding to the vertex h. In an embodiment, based on the derivation result of the q^{th} distance mean corresponding to the vertex h, the q^{th} weight of the vertex h is calculated, which may be represented as:

$$hint\_attention {\_weights}_{qh} = {( \frac{1}{{hint\_dist}_{qh}} )}^{a}$$

hint_attention_weights_{qh} represents the q^{th} weight corresponding to the vertex h, and hint_dist_{qh} represents the q^{th} distance mean of the vertex h; and a is a dynamic parameter, and may be adjusted based on an actual case, for example, a=4.

Further, the computer device performs, by using the q^{th} weight corresponding to each vertex, weighting processing on the vertex feature of the vertex, to obtain weighted features of the vertexes, and performs aggregation processing on the weighted features of the vertexes, to obtain the q^{th} aggregation feature, which may be specifically re resented as:

$${z}_{q} = {\sum }_{h = 0}^{N} hint\_attention {\_weights}_{q h} * {f}_{h}$$

z_{q} is the q^{th} aggregation feature, hint_attention_weights_{qh} represents the q^{th} weight corresponding to the vertex h, N is the quantity of vertexes in the mesh model, and fₕ is a vertex feature of the vertex h.

The attention submodule is invoked to aggregate the vertex features of the vertexes in the mesh model into the key vertex sets, to obtain the P aggregation features, so that the vertex features of the vertexes in the mesh model may be aggregated into the P key vertex sets according to an adaptive weight (hint_attention_weights), and the vertex features of the key vertexes in the P key vertex sets may also be effectively transferred to remaining vertexes (non-key vertexes) in the mesh model.

S506: Perform, by using a residual submodule, deep feature extraction processing on the vertex features of the vertexes, to obtain deep features of the vertexes.

In an implementation, the residual submodule includes a neural network layer and an activation layer. A process in which the computer device performs, by using the residual submodule, deep feature extraction processing on the vertex features of the vertexes, to obtain deep features of the vertexes includes: performing, by using the neural network layer, mapping processing on a vertex feature of a vertex j, to obtain a feature mapping result of the vertex j; performing, by using the activation layer, activation processing on the feature mapping result of the vertex j, to obtain an activated feature of the vertex j; and performing superposition processing on the activated feature of the vertex j and the vertex feature of the vertex j, to obtain a deep feature of the vertex j.

FIG. 9 is a schematic structural diagram of a residual submodule according to an embodiment of this application. As shown in FIG. 9, the residual submodule includes two multilayer perceptrons (neural network layers) and two activation layers. The multilayer perceptron is configured to perform mapping processing on a vertex feature of a vertex, to obtain a feature mapping result; and the activation layer is configured to perform activation processing on the feature mapping result, where an activation function configured by the activation layer may be a linear rectification function (ReLU) activation function.

Deep feature extraction processing is performed on the vertex features of the vertexes by using the residual submodule, so that the deep features (features at a deeper level) of the vertexes in the mesh model may be effectively extracted, thereby further improving accuracy of the skin weight prediction model.

Operation S504 to operation S506 may be performed in any order. For example, operation S506 is first performed, then operation S504 is performed, and then operation S505 is performed. AI ternatively, the operations may be synchronously performed. This is not limited in this application.

S507: Perform concatenation processing on the neighborhood feature of each vertex, the P aggregation features, and the deep feature of each vertex, to obtain fusion features of the vertexes in the mesh model.

In an implementation, the computer device may perform, by using a fusion model (for example, a fusion network), concatenation processing on the neighborhood feature of each vertex, the P aggregation features, and the deep feature of each vertex, to obtain the fusion features of the vertexes in the mesh model.

S508: Perform, by using the neural network layer, mapping processing on the fusion features of the vertexes and the topology information of the mesh model, to obtain a skin weight of the mesh model.

In operation S508, the fusion features of the vertexes and the topology information of the mesh model may be inputted into the neural network layer as input information of the neural network layer. The neural network layer is configured to perform mapping processing on the input information, to obtain the skin weight of the mesh model. The mapping processing is configured for performing nonlinear transformation on the input information to introduce nonlinearity.

The skin weight is configured for indicating a deformation influence degree of a joint point of the object on each vertex in the mesh model in the deformation process of the mesh model.

Further, the computer device may further obtain a rotation and translation matrix of the joint point of the object, and perform rotation and translation processing on the vertexes in the mesh model based on the skin weight of the mesh model and the rotation and translation matrix, to obtain a rotation and translation result of the mesh model. The mesh model includes any one of the following: a multi-layer mesh model, a single-layer mesh model, and a combined mesh model (which may be obtained by combining a plurality of single-layer mesh models).

In an embodiment, the object may be a virtual character in a game, and the mesh model may be a costume of the virtual character. The computer device obtains vertex features of vertexes in the costume of the virtual character and topology information of the costume, and obtains vertex relationship indication information. Then, the skin weight prediction model is configured to predict a skin weight of the costume based on the vertex relationship indication information, the vertex features, and the topology information of the costume. The computer device may render, by using skin weights of different costumes, effect images in which the virtual character wears different costumes. The computer device may render, by using a skin weight of a target costume, effect images in which the virtual character wears the target costume in different poses.

In another embodiment, the object may be an animation character in a three-dimensional animation, and the mesh model may be a three-dimensional costume. The computer device obtains vertex features of vertexes in the three-dimensional costume of the animation character and topology information of the three-dimensional costume, and obtains vertex relationship indication information. Then, the skin weight prediction model is configured to predict a skin weight of the three-dimensional costume based on the vertex relationship indication information, the vertex features, and the topology information of the three-dimensional costume. The computer device may render, by using skin weights of different three-dimensional costumes, effect images in which the animation character wears different three-dimensional costumes. The computer device may render, by using a skin weight of a target three-dimensional costume, effect images in which the animation character wears the target three-dimensional costume in different poses.

In still another embodiment, the object may be a person (for example, a real person) in a video or a picture, and the mesh model may be a virtual costume (for example, a three-dimensional model of a to-be-tried-on cloth). The computer device obtains vertex features of vertexes in the virtual costume tried by the person and topology information of the virtual costume, and obtains vertex relationship indication information. Then, the skin weight prediction model is configured to predict a skin weight of the virtual costume based on the vertex relationship indication information, the vertex features, and the topology information of the virtual costume. The computer device may composite, by using skin weights of different virtual costumes, trying-on effect images in which the person tries the virtual costumes on. The computer device may render, by using a skin weight of a target virtual costume, trying-on effect images in which the person wears the target virtual costume in different poses.

According to the image processing method provided in this application, a process of predicting a skin weight may be constrained (for example, a similarity relationship between skin weights of vertexes of different layers of clothes are constrained), to improve accuracy of predicting the skin weight, thereby satisfying requirements of a complex mesh model (for example, a multi-layer structured cloth or a combined cloth) on a similarity and deformation cooperativity of the skin weight.

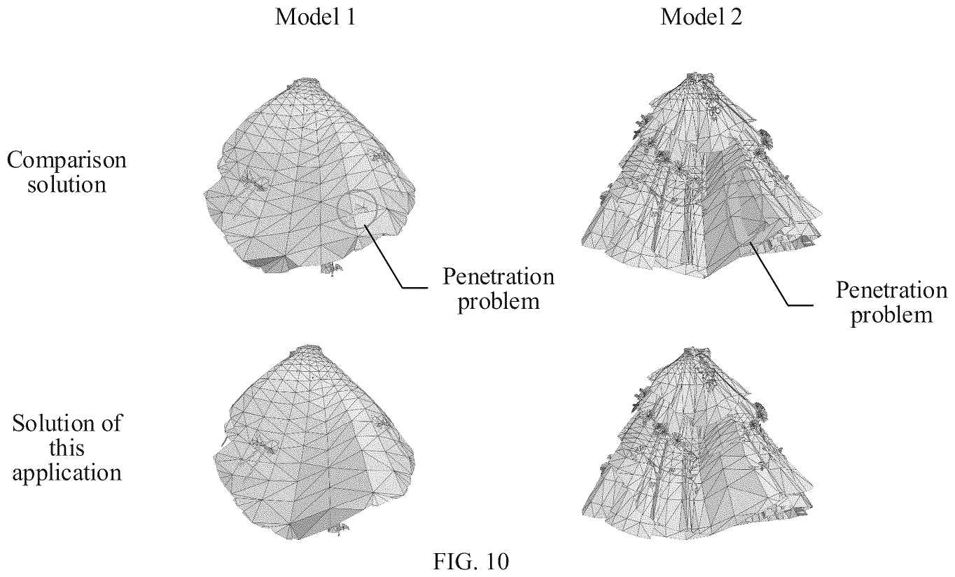

FIG. 10 is a diagram of comparison between effects according to an embodiment of this application. As shown in FIG. 10, based on the skin weight of the mesh model and the rotation and translation matrix of the joint point of the object that are obtained by using the image processing method provided in this application, compared with a result obtained in a comparison solution, in a result obtained by performing rotation and translation processing on the mesh model, a problem of “penetration” that occurs after rotation and translation are performed on the mesh model can be effectively resolved, thereby improving quality of the mesh model.

In this embodiment of this application, vertex features of vertexes in a mesh model of an object and topology information of the mesh model are obtained; and vertex relationship indication information is obtained, the vertex relationship indication information being configured for indicating vertexes having a constraint relationship in the mesh model. A skin weight prediction model is configured to predict a skin weight of the mesh model based on the vertex relationship indication information, the vertex features, and the topology information of the mesh model. It can be seen that, in a process of predicting the skin weight of the mesh model, skin weights of the vertexes in the mesh model are constrained by using the vertex relationship indication information, so that accuracy of predicting a skinning matrix of the mesh model can be improved, thereby improving quality of the mesh model obtained based on the skinning matrix of the mesh model. In addition, feature conversion processing is performed on P first neighbor matrices and the vertex features of the vertexes by using a neighbor submodule, to obtain neighborhood features of the vertexes, so that key vertex sets may be added to a second neighbor matrix, to aggregate neighborhood vertex features in the mesh model (for example, different layers of meshes), thereby constraining the skin weight of the vertexes. Deep feature extraction processing is performed on the vertex features of the vertexes by using a residual submodule, so that deep features (features at a deeper level) of the vertexes in the mesh model may be effectively extracted, thereby further improving accuracy of predicting the skin weight prediction model. An attention submodule is invoked to aggregate the vertex features of the vertexes in the mesh model into key vertex sets, so that the vertex features of the vertexes in the mesh model may be aggregated into P key vertex sets according to an adaptive weight, and vertex features of key vertexes in the P key vertex sets may also be effectively transferred to remaining vertexes (non-key vertexes) in the mesh model.

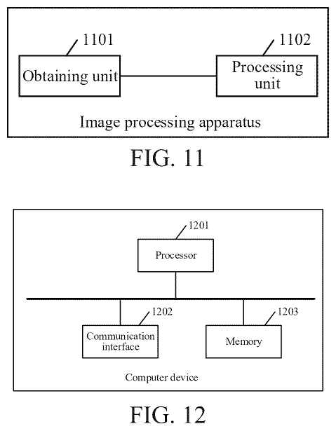

FIG. 11 is a schematic structural diagram of an image processing apparatus according to an embodiment of this application. The image processing apparatus shown in FIG. 11 may be carried in a computer device. The computer device may be specifically a terminal device or a server. The image processing apparatus shown in FIG. 11 may be configured to perform some or all functions of the method embodiments described in FIG. 2 and FIG. 5. Referring to FIG. 11, the image processing apparatus includes:
an obtaining unit 1101, configured to obtain vertex features of vertexes in a mesh model of an object and topology information of the mesh model, the topology information of the mesh model including a location relationship between a joint point of the object and each vertex in the mesh model and a connection relationship between the vertexes in the mesh model; and
obtain vertex relationship indication information, the vertex relationship indication information being configured for indicating vertexes having a constraint relationship in the mesh model, and the constraint relationship being a constraint relationship between two different vertexes; and
a processing unit 1102, configured to input the vertex relationship indication information, the vertex features, and the topology information of the mesh model to a skin weight prediction model, the skin weight prediction model being configured to predict a skin weight of the mesh model based on the vertex relationship indication information, the vertex features, and the topology information of the mesh model,
the skin weight of the mesh model being configured for indicating a deformation influence degree of the joint point of the object on each vertex in the mesh model in a deformation process of the mesh model.

In an embodiment, the skin weight prediction model includes a neural network layer and M feature fusion modules, M being a positive integer; and that the processing unit 1102 is configured to predict the skin weight of the mesh model based on the vertex relationship indication information, the vertex features, and the topology information of the mesh model specifically includes:
invoking the M feature fusion modules to perform feature fusion processing on the vertex relationship indication information and the vertex feature of each vertex in the mesh model, to obtain fusion features of the vertexes; and
performing, by using the neural network layer, mapping processing on the fusion features of the vertexes and the topology information of the mesh model, to obtain the skin weight of the mesh model.

In an implementation, the vertex relationship indication information includes P key vertex sets, P being a positive integer; each feature fusion module includes an attention submodule, a residual submodule, and a neighbor submodule; and a process in which the processing unit 1102 invokes the M feature fusion modules to perform feature fusion processing on the vertex relationship indication information and the vertex feature of each vertex in the mesh model, to obtain the fusion features of the vertexes includes:
obtaining P first neighbor matrices corresponding to the P key vertex sets, and performing, by using the neighbor submodule, feature conversion processing on the P first neighbor matrices and the vertex features of the vertexes, to obtain neighborhood features of the vertexes, the P first neighbor matrices being obtained after connecting edges between key vertexes in each key vertex set are established;
invoking the attention submodule to aggregate the vertex features of the vertexes in the mesh model into the key vertex sets, to obtain P aggregation features, the P aggregation features being in a one-to-one correspondence with the P key vertex sets; and a q^{th} aggregation feature being any one of the P aggregation features, the q^{th} aggregation feature corresponding to a q^{th} key vertex set in the P key vertex sets, the q^{th} aggregation feature being configured for indicating a similarity between a skin weight of a vertex in the mesh model and a skin weights of each key vertex in the q^{th} key vertex set, and q being a positive integer less than or equal to P;
performing, by using the residual submodule, deep feature extraction processing on the vertex features of the vertexes, to obtain deep features of the vertexes; and
performing concatenation processing on the neighborhood feature of each vertex, the P aggregation features, and the deep feature of each vertex, to obtain the fusion features of the vertexes in the mesh model.

In an implementation, a process in which the processing unit 1102 performs, by using the neighbor submodule, feature conversion processing on the P first neighbor matrices and the vertex features of the vertexes, to obtain the neighborhood features of the vertexes includes:
determining, by using a q^{th} first neighbor matrix, k neighboring vertexes of a key vertex j, the q^{th} first neighbor matrix being a first neighbor matrix of the q^{th} key vertex set, the key vertex j belonging to the q^{th} key vertex set, and k being a positive integer;
respectively calculating a difference between a vertex feature of the key vertex j and a vertex feature of each neighboring vertex in the k neighboring vertexes, to obtain k difference features; and
determining a largest value in the k difference features as a neighborhood feature of the key vertex j.

In an implementation, the topology information of the mesh model includes a second neighbor matrix, and the second neighbor matrix is obtained based on the connection relationship between the vertexes in the mesh model; and that the processing unit 1102 is configured to determine, by using the q^{th} first neighbor matrix, the k neighboring vertexes of the key vertex j specifically includes:
determining, by using the q^{th} first neighbor matrix, T key vertexes having connecting edges with the key vertex j, T being a positive integer; and
if T is greater than or equal to k, randomly selecting k vertexes from the T key vertexes as the k neighboring vertexes of the key vertex j; or
if T is less than k, determining, by using the second neighbor matrix, V vertexes having connecting edges with the key vertex j, randomly selecting (k−T) vertexes from the V vertexes, and using the T key vertexes and the selected (k−T) vertexes as the k neighboring vertexes of the key vertex j, V being a positive integer.

In an implementation, a process in which the processing unit 1102 is configured to invoke the attention submodule to aggregate the vertex features of the vertexes in the mesh model into the key vertex sets, to obtain the P aggregation features includes:
obtaining q^{th} weights corresponding to the vertexes in the mesh model, q being a positive integer less than or equal to P;
performing, by using the q^{th} weight corresponding to each vertex, weighting processing on the vertex feature of the vertex, to obtain weighted features of the vertexes; and
performing aggregation processing on the weighted features of the vertexes, to obtain the q^{th} aggregation feature.

In an implementation, a process in which the processing unit 1102 obtains the q^{th} weights corresponding to the vertexes in the mesh model includes:
performing mean processing on first distances between the key vertexes in the q^{th} key vertex set and a vertex h, to obtain a q^{th} distance mean corresponding to the vertex h, the vertex h being any vertex in the mesh model; and
determining a q^{th} weight of the vertex h based on a derivation result of the q^{th} distance mean corresponding to the vertex h.

In an implementation, the residual submodule includes a neural network layer and an activation layer; and a process in which the processing unit 1102 performs, by using the residual submodule, deep feature extraction processing on the vertex features of the vertexes, to obtain the deep features of the vertexes includes:
performing, by using the neural network layer, mapping processing on a vertex feature of the vertex h, to obtain a feature mapping result of the vertex h;
performing, by using the activation layer, activation processing on the feature mapping result of the vertex h, to obtain an activated feature of the vertex h; and
performing superposition processing on the activated feature of the vertex h and the vertex feature of the vertex h, to obtain a deep feature of the vertex h.

In an implementation, the joint point of the object includes at least one basic joint point and P additional joint points corresponding to the mesh model, P being a positive integer; and that the processing unit 1102 is configured to obtain the vertex relationship indication information specifically includes:
obtaining P key regions corresponding to the P additional joint points in the mesh model, each key region including at least two vertexes;
performing screening processing on vertexes in each key region, to obtain the P key vertex sets, the key vertexes in each key vertex set having the constraint relationship; and
generating the vertex relationship indication information based on the P key vertex sets.

In an implementation, a process in which the processing unit 1102 performs screening processing on the vertexes in each key region, to obtain the P key vertex sets includes:
adding a target vertex in a q^{th} key region and neighborhood vertexes of the target vertex to a candidate vertex set, a second distance between the target vertex and a q^{th} additional joint point being less than a second distance between another vertex other than the target vertex in the q^{th} key region and the q^{th} additional joint point; and the q^{th} key region being any one of the P key regions, the q^{th} key region corresponding to the q^{th} additional joint point in the P additional joint points, and q being a positive integer less than or equal to P;
obtaining marked weights of candidate vertexes and marked weights of neighborhood vertexes of each candidate vertex in the candidate vertex set;
performing mean processing on differences between the marked weight of each candidate vertex in the candidate vertex set and the marked weights of the neighborhood vertexes of the candidate vertex, to obtain a difference mean corresponding to each candidate vertex;
determining a candidate vertex having a largest difference mean as a representative vertex of the candidate vertex set; and
adding a first vertex in the ql key region to the q^{th} key vertex set, a difference between a difference mean of the first vertex and the difference mean of the representative vertex being less than a mean threshold.

In an implementation, that the processing unit 1102 is configured to obtain the vertex feature of each vertex in the mesh model of the object specifically includes:
obtaining location information and normal vectors of the vertexes in the mesh model;
respectively calculating, according to the location information of each vertex, a second distance between the vertex and each joint point of the object; and
combining the location information and the normal vector of each vertex with the second distance between the vertex and each joint point of the object, to obtain the vertex feature of the vertex.

In an implementation, the object includes N joint points, N being a positive integer; and that the processing unit 1102 is configured to predict the skin weight of the mesh model based on the vertex relationship indication information, the vertex features, and the topology information of the mesh model specifically includes:
predicting N predicted weights of each vertex in the mesh model based on the vertex relationship indication information, the vertex features, and the topology information of the mesh model, the N joint points of the object being in a one-to-one correspondence with the N predicted weights; a u^{th} predicted weight of the vertex h being configured for indicating a deformation influence degree of a joint point u on the vertex h in the deformation process of the mesh model; and the vertex h being any vertex in the mesh model, the u^{th} predicted weight corresponding to the joint point u, and u being a positive integer less than or equal to N;
selecting R largest predicted weights from the N predicted weights of each vertex as R key weights of each vertex, R being an integer greater than 1 and less than or equal to N; and
performing normalization processing on the R key weights of each vertex, to obtain the skin weight of the mesh model.

In an implementation, the processing unit 1102 is further configured to:
obtain a rotation and translation matrix of the joint point of the object; and
perform rotation and translation processing on the vertexes in the mesh model based on the skin weight of the mesh model and the rotation and translation matrix, to obtain a rotation and translation result of the mesh model,
the mesh model including any one of the following: a multi-layer mesh model, a single-layer mesh model, and a combined mesh model.

According to an embodiment of this application, some operations of the image processing methods shown in FIG. 2 and FIG. 5 may be performed by units of the image processing apparatus shown in FIG. 11. For example, operation S201 and operation S202 shown in FIG. 2 may be performed by the obtaining unit 1101 shown in FIG. 11, and operation S203 may be performed by the processing unit 1102 shown in FIG. 11; and operation S501 to operation S503 shown in FIG. 5 may be performed by the obtaining unit 1101 shown in FIG. 11, and operation S504 to operation S508 may be performed by the processing unit 1102 shown in FIG. 11. The units of the image processing apparatus shown in FIG. 11 may be separately or wholly combined into one or more other units, or one (or more) of the units herein may further be divided into multiple units of smaller functions. In this way, same operations can be implemented, and implementation of the technical effects of the embodiments of this application is not affected. The foregoing units are divided based on logical functions. In actual application, a function of one unit may also be implemented by a plurality of units, or functions of a plurality of units are implemented by one unit. In other embodiments of this application, the image processing apparatus may also include other units. In actual application, the functions may also be cooperatively implemented by the other units and may also be cooperatively implemented by a plurality of units.

According to another embodiment of this application, a computer program (including program code) that can perform the operations in the corresponding method shown in FIG. 2 and FIG. 5 may be run on a general computing apparatus, for example, a computer device, which includes processing elements and storage elements such as a central processing unit (CPU), a random access memory (RAM), and a read-only memory (ROM), to construct the image processing apparatus shown in FIG. 11 and implement the image processing method in the embodiments of this application. The computer program may be recorded in, for example, a computer-readable recording medium, and may be loaded into the foregoing computing apparatus by using the computer-readable recording medium, and run in the computing device.

Based on the same inventive idea, a principle of resolving problems and beneficial effects of the image processing apparatus provided in the embodiments of this application is similar to a principle of resolving problems and beneficial effects of the image processing method in the method embodiments of this application. Reference may be made to the implementation principle and beneficial effects of the method. For concise description, details are not described herein again.

FIG. 12 is a schematic structural diagram of a computer device according to an embodiment of this application. The computer device may be a terminal device or a server. As shown in FIG. 12, the computer device includes at least a processor 1201, a communication interface 1202, and a memory 1203. The processor 1201, the communication interface 1202, and the memory 1203 may be connected by using a bus or in another manner. The processor 1201 (or central processing unit (CPU)) is a calculation core and a control core of the computer device, which can analyze a variety of instructions in the computer device and process a variety of data of the computer device. For example, the CPU may be used to analyze an on/off instruction sent by the user to the computer device, and control the computer device to perform on/off operations. For another example, the CPU may transmit a variety of interaction data between internal structures of the computer device, and the like. In some embodiments, the communication interface 1202 may include a standard wired interface and a standard wireless interface (for example, a WI-FI or a mobile communication interface), and may be configured to transmit data under control of the processor 1201. The communication interface 1202 may further be configured to transmit and exchange data inside the computer device. The memory 1203 is a memory device in the computer device, and is configured to store a program and data. The memory 1203 herein may include an internal memory of the computer device, and may also include an expanded memory supported by the computer device. The memory 1203 provides storage space. The storage space stores an operating system of the computer device, which may include, but is not limited to an Android system, an IOS system, a Windows Phone system, and the like. This is not limited in this application.

An embodiment of this application further provides a computer-readable storage medium (Memory). The computer-readable storage medium is a memory device in the computer device and is configured to store a program and data. The computer-readable storage medium herein may include an internal storage medium of the computer device, and certainly, may also include an extended storage medium supported by the computer device. The computer-readable storage medium provides storage space, and a processing system of the computer device is stored in the storage space. In addition, a computer program suitable to be loaded and executed by the processor 1201 is further stored in the storage space. The computer-readable storage medium herein may be a high-speed RAM or a non-volatile memory, for example, at least one magnetic disk memory. In some embodiments, the computer-readable storage medium may alternatively be at least one computer-readable storage medium located away from the foregoing processor.

In an embodiment, the processor 1201 performs, by running the computer program in the memory 1203, the image processing method in the forgoing method embodiments.

Based on the same inventive idea, a principle of resolving problems and beneficial effects of the computer device provided in the embodiments of this application is similar to a principle of resolving problems and beneficial effects of the image processing method in the method embodiments of this application. Reference may be made to the implementation principle and beneficial effects of the method. For concise description, details are not described herein again.

An embodiment of this application further provides a computer-readable storage medium. The computer-readable storage medium has a computer program stored therein. The computer program is suitable for being loaded and executed by a processor to perform the image processing method in the forgoing method embodiments.

An embodiment of this application further provides a computer program product. The computer program product includes a computer program, and the computer program is stored in a computer-readable storage medium. A processor of a computer device reads the computer program from the computer-readable storage medium, and the processor executes the computer program, to cause the computer device to perform the foregoing image processing method. The computer-readable storage medium may include: a flash drive, a read-only memory (ROM), a random access memory (RAM), a magnetic disk, an optical disc, or the like.

What is claimed is:

1. An image processing method performed by a computer device, the method comprising:
obtaining vertex features of vertexes in a mesh model of an object and topology information of the mesh model, the topology information of the mesh model comprising a location relationship between a joint point of the object and each vertex in the mesh model and a connection relationship between the vertexes in the mesh model;
obtaining vertex relationship indication information indicating vertexes having a constraint relationship between two different vertexes in the mesh model; and
predicting a skin weight of the mesh model by applying the vertex relationship indication information, the vertex features, and the topology information of the mesh model to a skin weight prediction model, the skin weight of the mesh model indicating a deformation influence degree of the joint point of the object on each vertex in the mesh model in a deformation process of the mesh model.

2. The method according to claim 1, wherein the skin weight prediction model comprises a neural network layer and M feature fusion modules, M being a positive integer; and the predicting the skin weight of the mesh model based on the vertex relationship indication information, the vertex features, and the topology information of the mesh model comprises:
invoking the M feature fusion modules to perform feature fusion processing on the vertex relationship indication information and the vertex feature of each vertex in the mesh model, to obtain fusion features of the vertexes; and
performing, by using the neural network layer, mapping processing on the fusion features of the vertexes and the topology information of the mesh model, to obtain the skin weight of the mesh model.

3. The method according to claim 2, wherein the vertex relationship indication information comprises P key vertex sets, P being a positive integer; each feature fusion module comprises an attention submodule, a residual submodule, and a neighbor submodule; and the invoking the M feature fusion modules to perform feature fusion processing on the vertex relationship indication information and the vertex feature of each vertex in the mesh model, to obtain fusion features of the vertexes comprises:
obtaining P first neighbor matrices corresponding to the P key vertex sets, and performing, by using the neighbor submodule, feature conversion processing on the P first neighbor matrices and the vertex features of the vertexes, to obtain neighborhood features of the vertexes, the P first neighbor matrices being obtained after connecting edges between key vertexes in each key vertex set are established;
invoking the attention submodule to aggregate the vertex features of the vertexes in the mesh model into the key vertex sets, to obtain P aggregation features, the P aggregation features being in a one-to-one correspondence with the P key vertex sets; and a q^{th} aggregation feature being any one of the P aggregation features, the q^{th} aggregation feature corresponding to a q^{th} key vertex set in the P key vertex sets, the q^{th} aggregation feature being configured for indicating a similarity between a skin weight of a vertex in the mesh model and a skin weights of each key vertex in the q^{th} key vertex set, and q being a positive integer less than or equal to P;
performing, by using the residual submodule, deep feature extraction processing on the vertex features of the vertexes, to obtain deep features of the vertexes; and
performing concatenation processing on the neighborhood feature of each vertex, the P aggregation features, and the deep feature of each vertex, to obtain the fusion features of the vertexes in the mesh model.

4. The method according to claim 3, wherein the performing, by using the neighbor submodule, feature conversion processing on the P first neighbor matrices and the vertex features of the vertexes, to obtain neighborhood features of the vertexes comprises:
determining, by using a q^{th} first neighbor matrix, k neighboring vertexes of a key vertex j, the q^{th} first neighbor matrix being a first neighbor matrix of the q^{th} key vertex set, the key vertex j belonging to the q^{th} key vertex set, and k being a positive integer;
respectively calculating a difference between a vertex feature of the key vertex j and a vertex feature of each neighboring vertex in the k neighboring vertexes, to obtain k difference features; and
determining a largest value in the k difference features as a neighborhood feature of the key vertex j.

5. The method according to claim 4, wherein the topology information of the mesh model comprises a second neighbor matrix, and the second neighbor matrix is obtained based on the connection relationship between the vertexes in the mesh model; and the determining, by using a ql first neighbor matrix, k neighboring vertexes of a key vertex j comprises:
determining, by using the q^{th} first neighbor matrix, T key vertexes having connecting edges with the key vertex j, T being a positive integer;
when T is greater than or equal to k, randomly selecting k vertexes from the T key vertexes as the k neighboring vertexes of the key vertex j; and
when T is less than k, determining, by using the second neighbor matrix, V vertexes having connecting edges with the key vertex j, randomly selecting (k−T) vertexes from the V vertexes, and using the T key vertexes and the selected (k−T) vertexes as the k neighboring vertexes of the key vertex j, V being a positive integer.

6. The method according to claim 5, wherein the invoking the attention submodule to aggregate the vertex features of the vertexes in the mesh model into the key vertex sets, to obtain P aggregation features comprises:
obtaining q^{th} weights corresponding to the vertexes in the mesh model;
performing, by using the q^{th} weight corresponding to each vertex, weighting processing on the vertex feature of the vertex, to obtain weighted features of the vertexes; and
performing aggregation processing on the weighted features of the vertexes, to obtain the q^{th} aggregation feature.

7. The method according to claim 6, wherein the obtaining q^{th} weights corresponding to the vertexes in the mesh model comprises:
performing mean processing on first distances between the key vertexes in the q^{th} key vertex set and a vertex h, to obtain a q^{th} distance mean corresponding to the vertex h, the vertex h being any vertex in the mesh model; and
determining a q^{th} weight of the vertex h based on a derivation result of the q^{th} distance mean corresponding to the vertex h.

8. The method according to claim 7, wherein the residual submodule comprises a neural network layer and an activation layer; and the performing, by using the residual submodule, deep feature extraction processing on the vertex features of the vertexes, to obtain deep features of the vertexes comprises:
performing, by using the neural network layer, mapping processing on a vertex feature of the vertex h, to obtain a feature mapping result of the vertex h;
performing, by using the activation layer, activation processing on the feature mapping result of the vertex h, to obtain an activated feature of the vertex h; and
performing superposition processing on the activated feature of the vertex h and the vertex feature of the vertex h, to obtain a deep feature of the vertex h.

9. The method according to claim 8, wherein the joint point of the object comprises at least one basic joint point and P additional joint points corresponding to the mesh model, P being a positive integer; and the obtaining vertex relationship indication information comprises:
obtaining P key regions corresponding to the P additional joint points in the mesh model, each key region comprising at least two vertexes;
performing screening processing on vertexes in each key region, to obtain the P key vertex sets, the key vertexes in each key vertex set having the constraint relationship; and
generating the vertex relationship indication information based on the P key vertex sets.

10. The method according to claim 1, wherein the obtaining vertex features of vertexes in a mesh model of an object comprises:
obtaining location information and normal vectors of the vertexes in the mesh model;
respectively calculating, according to the location information of each vertex, a second distance between the vertex and each joint point of the object; and
combining the location information and the normal vector of each vertex with the second distance between the vertex and each joint point of the object, to obtain the vertex feature of the vertex.

11. The method according to claim 1, wherein the object comprises N joint points, N being a positive integer; and the predicting a skin weight of the mesh model by applying the vertex relationship indication information, the vertex features, and the topology information of the mesh model to the skin weight prediction model comprises:
predicting N predicted weights of each vertex in the mesh model based on the vertex relationship indication information, the vertex features, and the topology information of the mesh model, the N joint points of the object being in a one-to-one correspondence with the N predicted weights; a u^{th} predicted weight of the vertex h being configured for indicating a deformation influence degree of a joint point u on the vertex h in the deformation process of the mesh model; and the vertex h being any vertex in the mesh model, the u^{th} predicted weight corresponding to the joint point u, and u being a positive integer less than or equal to N;
selecting R largest predicted weights from the N predicted weights of each vertex as R key weights of each vertex, R being an integer greater than 1 and less than or equal to N; and
performing normalization processing on the R key weights of each vertex, to obtain the skin weight of the mesh model.

12. The method according to claim 1, further comprising:
obtaining a rotation and translation matrix of the joint point of the object; and
performing rotation and translation on the vertexes in the mesh model based on the skin weight of the mesh model and the rotation and translation matrix, to obtain a rotation and translation result of the mesh model.

13. A computer device, comprising:
a memory, having a computer program stored therein; and
a processor, configured to execute the computer program to cause the computer device to implement an image processing method including:
obtaining vertex features of vertexes in a mesh model of an object and topology information of the mesh model, the topology information of the mesh model comprising a location relationship between a joint point of the object and each vertex in the mesh model and a connection relationship between the vertexes in the mesh model;
obtaining vertex relationship indication information indicating vertexes having a constraint relationship between two different vertexes in the mesh model; and
predicting a skin weight of the mesh model by applying the vertex relationship indication information, the vertex features, and the topology information of the mesh model to a skin weight prediction model, the skin weight of the mesh model indicating a deformation influence degree of the joint point of the object on each vertex in the mesh model in a deformation process of the mesh model.

14. The computer device according to claim 13, wherein the skin weight prediction model comprises a neural network layer and M feature fusion modules, M being a positive integer; and the predicting the skin weight of the mesh model based on the vertex relationship indication information, the vertex features, and the topology information of the mesh model comprises:
invoking the M feature fusion modules to perform feature fusion processing on the vertex relationship indication information and the vertex feature of each vertex in the mesh model, to obtain fusion features of the vertexes; and
performing, by using the neural network layer, mapping processing on the fusion features of the vertexes and the topology information of the mesh model, to obtain the skin weight of the mesh model.

15. The computer device according to claim 13, wherein the obtaining vertex features of vertexes in a mesh model of an object comprises:
obtaining location information and normal vectors of the vertexes in the mesh model;
respectively calculating, according to the location information of each vertex, a second distance between the vertex and each joint point of the object; and
combining the location information and the normal vector of each vertex with the second distance between the vertex and each joint point of the object, to obtain the vertex feature of the vertex.

16. The computer device according to claim 13, wherein the method further comprises:
obtaining a rotation and translation matrix of the joint point of the object; and
performing rotation and translation on the vertexes in the mesh model based on the skin weight of the mesh model and the rotation and translation matrix, to obtain a rotation and translation result of the mesh model.

17. A non-transitory computer-readable storage medium, having a computer program stored therein, the computer program being suitable for being loaded and executed by a processor of a computer device and causing the computer device to perform an image processing method including:
obtaining vertex features of vertexes in a mesh model of an object and topology information of the mesh model, the topology information of the mesh model comprising a location relationship between a joint point of the object and each vertex in the mesh model and a connection relationship between the vertexes in the mesh model;
obtaining vertex relationship indication information indicating vertexes having a constraint relationship between two different vertexes in the mesh model; and
predicting a skin weight of the mesh model by applying the vertex relationship indication information, the vertex features, and the topology information of the mesh model to a skin weight prediction model, the skin weight of the mesh model indicating a deformation influence degree of the joint point of the object on each vertex in the mesh model in a deformation process of the mesh model.

18. The non-transitory computer-readable storage medium according to claim 17, wherein the skin weight prediction model comprises a neural network layer and M feature fusion modules, M being a positive integer; and the predicting the skin weight of the mesh model based on the vertex relationship indication information, the vertex features, and the topology information of the mesh model comprises:
invoking the M feature fusion modules to perform feature fusion processing on the vertex relationship indication information and the vertex feature of each vertex in the mesh model, to obtain fusion features of the vertexes; and
performing, by using the neural network layer, mapping processing on the fusion features of the vertexes and the topology information of the mesh model, to obtain the skin weight of the mesh model.

19. The non-transitory computer-readable storage medium according to claim 17, wherein the obtaining vertex features of vertexes in a mesh model of an object comprises:
obtaining location information and normal vectors of the vertexes in the mesh model;
respectively calculating, according to the location information of each vertex, a second distance between the vertex and each joint point of the object; and
combining the location information and the normal vector of each vertex with the second distance between the vertex and each joint point of the object, to obtain the vertex feature of the vertex.

20. The non-transitory computer-readable storage medium according to claim 17, wherein the method further comprises:
obtaining a rotation and translation matrix of the joint point of the object; and
performing rotation and translation on the vertexes in the mesh model based on the skin weight of the mesh model and the rotation and translation matrix, to obtain a rotation and translation result of the mesh model.
